(19) United States
(12) Patent Application Publication
(10) Pub. No.: US 2026/0265963 A1
(43) Pub. Date: Sep. 10, 2026

(54) AIRBAG-USE POLYESTER BASE FABRIC

(71) Applicant: TOYOBO CO., LTD., Osaka (JP)

(72) Inventor: Kota GOTO, Shiga (JP)

(21) Appl. No.: 19/167,927

(22) PCT Filed: Mar. 27, 2024
(86) PCT No.: PCT/JP2024/012495

§ 371 Date: Sep. 23, 2025

(30) Foreign Application Priority Data
Mar. 30, 2023 (JP) 2023-055923

(51) Int. Cl. D03D 15/283; B60R 21/235; D06N 3/00; D06N 3/12

(52) U.S. Cl. CPC D03D 15/283; B60R 21/235; D06N 3/0006; D06N 3/0036; D06N 3/0077; D06N 3/0088; D06N 3/128; B60R 2021/23509; D06N 2211/00; D10B 2331/04; D10B 2401/062; D10B 2401/063; D10B 2505/124

(57) ABSTRACT

The present invention aims to provide a polyester base fabric for airbags using polyester fibers that enable a reduction in carbon dioxide emissions. The polyester base fabric, while its poor packageability is improved, suppresses a reduction in air permeability after being rubbed during packaging and/or deployment. The present invention provides a polyester base fabric for airbags as a solution to the problem, the polyester base fabric comprising a woven fabric containing polyester fibers and having silicone resin applied in an amount of 5 g/m² to 25 g/m² to one side of the woven fabric, wherein an average stiffness in the warp and weft directions is 15 N or less, a first local maximum of tear strength is 300 N or more in each of the warp direction and the weft direction, an average slope from the origin to a point where the stress is 300 N in the warp and weft directions is 7.0 or less in a stress-strain curve obtained in a tear test, with a vertical axis representing stress (N) and a horizontal axis representing strain (%), and an average air permeability in the warp and weft directions after 200 scrub tests is 0.3 cc/cm²/sec or less.

### TECHNICAL FIELD

The present invention relates to a polyester base fabric for airbags.

### BACKGROUND ART

In recent years, airbags have been widely installed in automobiles as safety protection devices for occupants, and installed in various places, such as those for the driver seat and the front passenger seat, those for thigh protection built into seats, and curtain airbags that are deployed along side windows. The volume of base fabrics for airbags used per vehicle is on the rise. The base fabrics used in current airbags are mainly formed from polyamide fibers, which have properties suitable for the base fabric for airbags, particularly nylon 6,6 fibers. However, polyamide fibers require a greater amount of energy for production (i.e., carbon dioxide emissions are higher) than polyester fibers, and the emissions increase as airbags are more widely used. As a countermeasure in response to the current social demands that place importance on SDGs, there is a demand for base fabrics made of polyester fibers with lower carbon dioxide emissions than polyamide fibers.

However, polyester is characteristically harder than nylon and thus disadvantageously has poor packageability. Further, polyester base fabrics without amide groups disadvantageously have poor adhesion to silicone resin used as a coating agent, compared to adhesion of nylon base fabrics to silicone resin. In such a case, if workers apply high strain to a coated fabric during sewing and packaging, base fabrics will be rubbed against each other, easily causing separation of the silicone resin. This will cause friction between the base fabrics during deployment and the silicone resin will be separated, resulting in an increase in air permeability.

To meet the needs, for example, PTL 1 proposes a base fabric for airbags intended to maintain its performance after aging degradation by defining the abrasion resistance after hydrothermal aging. However, PTL 1 is silent about durability (maintenance of low air permeability) after rubbing. PLT 2 describes air permeability after the fabric is stretched only lengthwise or widthwise, and fails to evaluate the shear during actual packaging and/or deployment.

### CITATION LIST

### Patent Literature

PTL 1: WO2021/132575
PTL 2: JP2002-220761A

### SUMMARY OF INVENTION

### Technical Problem

The present invention was made in view of the problems of the art and aims to provide a polyester base fabric for airbags using polyester fibers that enable a reduction in carbon dioxide emissions, wherein the polyester base fabric, while its poor packageability is improved, suppresses a reduction in air permeability after being rubbed during packaging and/or deployment.

### Solution to Problem

As a result of extensive study to solve the above problems, the present inventor finally completed the present invention. Specifically, the present invention is as follows.

1. A polyester base fabric for airbags, comprising a woven fabric containing polyester fibers and having silicone resin applied in an amount of 5 g/m² to 25 g/m² to one side of the woven fabric,
wherein an average stiffness in the warp and weft directions is 15 N or less,
a first local maximum of tear strength is 300 N or more in each of the warp direction and the weft direction,
an average slope from the origin to a point where the stress is 300 N in the warp and weft directions is 7.0 or less in a stress-strain curve obtained in a tear test, with a vertical axis representing stress (N) and a horizontal axis representing strain (%), and
an average air permeability in the warp and weft directions after 200 scrub tests is 0.3 cc/cm²/sec or less.

2. The polyester base fabric for airbags according to 1, wherein the polyester base fabric contains 10 ppm or more of zirconium.

3. The polyester base fabric for airbags according to 1 or 2, wherein the polyester fibers have a total fineness of 200 dtex to 600 dtex.

4. An airbag comprising the polyester base fabric for airbags according to any one of 1 to 3.

### Advantageous Effects of Invention

The present invention can provide a base fabric with various high-level characteristics to protect the occupants in an automobile when used in airbags, even when the base fabric is formed from a polyester fiber.

### DESCRIPTION OF EMBODIMENTS

The technical idea of the present invention is to use silicone resin that is relatively soft and having excellent adhesion in order to provide a base fabric for airbags having an air permeability of 0.3 cc/cm²/sec or less after 200 scrub tests and a stiffness of 15 N or less.

The present inventor found that the low air permeability required for a coated fabric even after the coated fabric is rubbed during sewing and packaging by workers and even after friction occurs between base fabrics during deployment is highly relevant to the air permeability being 0.3 cc/cm²/sec or less after 200 scrub tests. When the air permeability exceeds 0.3 cc/cm²/sec, problems such as the inability to maintain internal pressure during deployment are likely to occur. The air permeability is more preferably 0.20 cc/cm²/sec or less, and still more preferably 0.1 cc/cm²/sec or less.

It may be possible to increase the coating amount of coating resin in order to satisfy the low air permeability after scrub tests. However, an excessively increased coating amount will cause an increase in stiffness. Excessively high stiffness may result in low packageability when the stiffness of the woven fabric is high. The stiffness is preferably 15 N or less, more preferably 12 N or less, and still more preferably 9 N or less. Considering the fineness and density in the present invention, it is difficult to adjust the stiffness to 3.0 or less, and so the lower limit of the stiffness is not particularly limited, but it is preferably 3.0 or more.

The polyester base fabric for airbags of the present invention has silicone resin applied in an amount of 5 g/m² to 25 g/m² to one side of the polyester base fabric. Silicone resin is relatively inexpensive and can achieve an excellent level of low air permeability. When the coating amount of the resin is within the above range, it is possible to achieve flexibility and packageability while sufficiently suppressing air permeability. The coating amount is more preferably 5 g/m² to 23 g/m² and particularly preferably 5 g/m² to 20 g/m². A coating amount of 5 g/m² or more improves non-flammability, making it easy to comply with legal standards. A coating amount of 25 g/m² or less results in appropriate hardness and thickness, which tends to improve packageability. Preferably, the silicone resin contains 100% silicone. Thus, preferably, the polyester base fabric for airbags of the present invention has the above weight (silicon equivalent weight) of silicone resin per area applied to one side of the polyester base fabric. The silicone is preferably one having a molecular weight of 30000 to 70000 and is more preferably one having a molecular weight of 40000 to 60000.

Keys to maintaining low air permeability after scrub tests with an optimal stiffness are “an improvement in adhesion by promoting bonding between the base fabric and silicone resin” and “the flexibility of the applied resin.”

In the airbag base fabric of the present invention, preferably, the concentration of zirconium in the base fabric for airbags is 10 ppm or more in order to promote bonding between the base fabric and silicone resin to improve adhesion. Zirconium can be contained, for example, as a part of an organic zirconium compound in a liquid silicone resin composition that is used when applying the silicone resin to the airbag base fabric. Examples of such organic zirconium compounds include zirconium octylate, zirconium acetylacetonate, and the like. Zirconium, which has a high affinity for oxygen, easily bonds with carboxy groups and hydroxy groups, and can crosslink and form bonds between organic compounds having these functional groups. Thus, promoting bonding between the polyester base fabric having carboxy groups and hydroxy groups and the silicone resin results in improved adhesion. The concentration of zirconium may be more preferably 15 ppm or more, and particularly preferably 20 ppm or more. The upper limit of the concentration of zirconium is not particularly limited, but it is preferably 100 ppm or less in terms of the relationship between the polyester base fabric and the coating agent that are used.

The desired effect of the airbag base fabric of the present invention is highly associated with the flexibility of the applied resin. Specifically, it is important that a first local maximum of tear strength is 300 N or more in each of the warp direction and the weft direction. The first local maximum of tear strength is a first maximum peak in a tear test. When a stress exceeding the local maximum is applied during deployment, the base fabric cannot withstand the stress and is likely to break and burst. The first local maximum of tear strength is more preferably 320 N or more, still more preferably 350 N or more, and particularly preferably 400 N or more. The upper limit of the first local maximum of tear strength is not particularly limited, but it is preferably 1000 N or less in terms of the characteristics of the base fabric.

It is also important that an average slope from the origin to a point where the stress is 300 N in each of the warp direction and the weft direction is 7.0 or less in a stress-strain curve obtained in a tear test, with a vertical axis representing stress (N) and a horizontal axis representing strain (%). The tear strength increases as the threads that make up the base fabric move, get entangled with each other, and tear apart, so it is highly associated with the flexibility of the applied resin. This slope is a combination of stress to deformation of the base fabric and stress to deformation of the resin. The gentler the slope, the more easily the deformation occurs, meaning that the resin is more flexible. The present inventor further found that the flexibility of the resin affects not only the tear strength but also the conformability to the base fabric, and that it is also associated with resistance to the separation mentioned above. The slope is more preferably 6.8 or less, and particularly preferably 6.7 or less. The lower limit of the slope is not particularly limited, but it is preferably 5.0 or more in terms of the characteristics of the base fabric.

The polyester base fabric for airbags of the present invention contains polyester fibers. The polyester base fabric for airbags of the present invention may consist of polyester fibers, may substantially consist of polyester fibers, or may further contain one or more other fibers in addition to the polyester fibers. Examples of other fibers include polyamide fibers, particularly, nylon 6,6 fibers and the like. Even when the polyester base fabric for airbags of the present invention further contains other non-polyester fibers, the polyester fibers are the main component, and the proportion of the polyester fibers in the total fibers constituting the base fabric is preferably 80 mass % or more, more preferably 90 mass % or more, still more preferably 95 mass % or more, and yet still more preferably 98 mass % or more.

Preferably, the polyester base fabric for airbags of the present invention contains polyester fibers having a total fineness of 200 to 600 dtex. Although polyester fibers are more rigid than nylon 6,6 fibers and tend to result in poor packageability, polyester fibers having a total fineness of 200 dtex or more do not have the need to overly increase the weaving density and thus suppress an excessive increase in the binding force of warp and weft yarns, making it easy for packageability in an airbag module to fall within an appropriate range. Polyester fibers having a total fineness of 600 dtex or less make it easy to suppress an excessive increase in rigidity of the yarns constituting the woven fabric.

Preferably, the polyester base fabric for airbags of the present invention contains polyester fibers having a single-filament fineness of 6.0 dtex or less. Polyester fibers having a single-filament fineness of 6.0 dtex or less can achieve spinnability together with packageability of airbags.

Considering the restraint capacity use rate (RR) and the number of scrub tests, the cover factor (CF) of the polyester base fabric for airbags of the present invention is preferably 1900 to 2600. The lower limit of the cover factor (CF) is more preferably 2200, and the upper limit of the cover factor (CF) is more preferably 2500. The CF is calculated based on the following formula:

$$CF = ( √ A ) \times ( W 1 ) + ( √ B ) \times ( W 2 )$$

where A and B respectively represent the thickness (dtex) of warp yarn and the thickness (dtex) of weft yarn, and W1 and W2 respectively represent the warp weaving density and the weft weaving density (yarns/2.54 cm).

The areal weight of the polyester base fabric for airbags of the present invention is preferably 300 g/m² or less, more preferably 230 g/m², and still more preferably 220 g/m². An areal weight within this range makes it easy to reduce the weight of the airbag base fabric and further improves packageability into a module.

The lower limit of the areal weight of the polyester base fabric for airbags of the present invention is not particularly limited as long as it is within the range that can achieve satisfactory low air permeability when the polyester base fabric is used for airbags. A polyester fabric with an areal weight of 180 g/m² or more is considered to have low air permeability suitable for use as an airbag.

Examples of polyester fibers for use in the polyester base fabric for airbags of the present invention include polyethylene terephthalate, polybutylene terephthalate, and the like. The polyester fibers may be fibers made of a copolymerized polyester formed by copolymerizing polyethylene terephthalate or polybutylene terephthalate with an aliphatic dicarboxylic acid such as isophthalic acid, 5-sodium sulfoisophthalic acid, or adipic acid, as an acid component.

The polyester base fabric for airbags of the present invention preferably has a weaving density of 40 threads/2.54 cm or more, and more preferably 46 threads/2.54 cm or more in each of the warp direction and the weft direction. A weaving density of 46 threads/2.54 cm or more can suppress the deforming of the base fabric structure during the weaving process. The upper limit of the weaving density is not particularly limited, but it is preferably 70 threads/2.54 cm or less, due to the restriction of weft insertion in weaving.

The tensile strength of the polyester base fabric for airbags of the present invention is preferably 500 N/cm or more and more preferably 550 N/cm or more in terms of mechanical characteristics. The upper limit of the tensile strength is not particularly limited, but it is preferably 1000 N/cm or less, and more preferably 900 N/cm or less in relation to the total fineness and tensile strength of polyester multifilament for use, and the weaving density of the airbag base fabric.

The following describes methods suitable for obtaining the polyester base fabric for airbags of the present invention in detail. However, the polyester base fabric for airbags of the present invention is not limited to the base fabric produced by these methods.

The warp yarn tension in weaving the polyester base fabric for airbags of the present invention is preferably 50 to 200 cN/thread. A warp yarn tension of 50 cN/thread or more makes it unlikely for slack to occur in the warp yarn during weaving, for defects to form in the fabric, or for a loom to stop. A warp yarn tension of 200 cN/thread or less makes it easier to prevent an excessive load to be applied to the warp yarn, thus reducing defects in the fabric.

A shrinkage process may be, for example, a hydrothermal process or a heat-setting process as typified by a pin tenter. A hydrothermal process, which uses hot water for the shrinkage process, is particularly preferred. Hot water can be used by a method such as immersing the woven fabric obtained by weaving in hot water or spraying the woven fabric with hot water. The temperature of hot water is preferably about 80° C. to 100° C., and more preferably 95° C. or higher. A hot water temperature within the above range is preferred because it allows the greige fabric to efficiently shrink after weaving and improves the crimp ratio of the base fabric. The woven fabric obtained by weaving can be dried first and then subjected to a shrinkage process. However, it is advantageous in terms of production costs if the woven fabric obtained by weaving is subjected to a shrinkage process without being dried and then subjected to dry finishing.

Preferably, the drying temperature of hot-air drying in the production step of the polyester base fabric for airbags of the present invention is adjusted such that the base fabric has a surface temperature of 100° C. to 150° C. at the outlet of the dryer. A surface temperature of the base fabric within the above range allows the base fabric to be sufficiently dried and even can improve the crimp ratio of the fabric by hot air. Preferably, the temperature of the hot air dryer is adjusted such that the base fabric has a surface temperature within the range of 100° C. to 150° C. at the outlet of the dryer. For this purpose, preferably, the temperature of the hot air dryer is set to 130° C. to 180° C.

The resin viscosity of silicone resin for use in the polyester base fabric for airbags of the present invention is preferably 10 Pa·sec or more, and more preferably 15 Pa·sec or more. Although the upper limit is not particularly limited, a resin viscosity of 40 Pa·sec or less allows the resin to be present at woven-mesh portions formed by the warp and weft yarns on the non-coated surface, which is essential to improve the tensile strength of the polyester base fabric after being coated. As long as the viscosity can be adjusted to fall within the above range, either a solvent-based resin or a solvent-free resin may be used. However, a solvent-free resin may be preferable, given the environmental impact. When a resin composition containing additives other than resin is used, the viscosity of the resin composition needs to be controlled within the above viscosity range.

Preferably, the resin has a film strength of 10 MPa or less and a film elongation of 250% or more. In general, the film strength and the film elongation are cooperative physical properties. A film elongation of 250% or more allows the resin to stretch, and increases the conformability of the coated fabric during a scrub test, thus achieving high crumpling resistance. A preferred range of the film elongation is 300% or more. The upper limit of the film strength is not particularly limited, but it is preferably 10 MPa or less. Samples for measuring the film strength and elongation of silicone resin are prepared by pressing silicone resin at 200° C. and 10 MPa for 1 minute using a hot press machine to produce a resin film having a constant thickness of 0.2 mm. These samples are used in a tensile test.

Preferably, the resin has an elongation recovery rate of 97% or more after 10 cycles of 50% strain. Shrinkage that occurs during packaging causes stretching of the coated resin. When the resin is stretched relative to base fabric at the time of deployment, air may leak through a gap between the resin and the base fabric. The elongation recovery rate is more preferably 98% or more.

In the present invention, a conventionally publicly known method is used to apply the resin. In terms of ease of adjusting the coating amount and impact of contamination with foreign matter (protrusions), coating by knife coating, particularly the knife-on-air method, is most preferable. The knife-on-bed method allows the resin to easily penetrate into the interior of the woven fabric, but makes it difficult for the resin to remain on the woven fabric surface. This makes it difficult to achieve the ventilation control essentially required in coated fabrics. In the present invention, the knife for use in knife coating may have a blade with a semicircle or square tip shape, for example.

In knife coating by the knife-on-air method, the base fabric tension in the travel direction is preferably 500 to 2000 N/m, and particularly preferably 1000 to 1800 N/m. A base fabric tension of 500 N/m or more in the travel direction may result in a base woven fabric without excessively bulky selvages, making it easy to prevent a large difference in the coating amount between the center portion and end portions of the base fabric. A fabric tension of 2000 N/m or less in the travel direction may eliminate the space between the warp and weft yarns, making it easy to prevent a situation in which no resin can be present at woven-mesh portions formed by the warp and weft yarns on the uncoated surface, and also making it easy to prevent stretching of the base fabric during coating and a reduction in crimp ratio of the base fabric.

In the present invention, it is important that the push-in depth of the knife is 1 to 6 mm. The push-in depth of the knife is equivalent to the amount by which the knife is pushed downward from the top surface of the bed in the knife-on-air method, in which the height at the top surface immediately before pushing in is determined to be 0 mm. The push-in depth is more preferably 1.5 to 4.5 mm. A push-in depth of 1 mm or more easily allows the resin to be present at woven-mesh portions formed by the warp and weft yarns on the uncoated surface, which is the purpose of this invention. A push-in depth of 6 mm or less makes it easy for the resin to be present at the woven fabric surface, which makes it easy to achieve the ventilation control that is essentially required in coated fabrics.

The method for drying and curing the applied coating agent can be a typical heating method that uses hot air, infrared light, microwaves, or the like. Regarding the curing temperature and curing time of coating, preferably, the base fabric has a surface temperature of 165° C. to 200° C. at the outlet of the heat treatment device. A surface temperature of the base fabric within this range can sufficiently cure silicone resin and can even improve the crimp ratio of the base fabric by heat. Preferably, the temperature of the heat treatment device is adjusted such that the base fabric has a surface temperature within the range of 165° C. to 200° C. at the outlet of the heat treatment device, so the temperature of the heat treatment device is preferably set to 200° C. to 220° C.

The airbags formed from the polyester base fabric for airbags of the present invention are suitable for use in driver airbags, front-passenger airbags, curtain airbags, side airbags, knee airbags, seat airbags, and reinforcement fabrics, for example. Thus, these products are also included in the scope of the present invention. The airbags formed from the airbag base fabric of the present invention are preferably those that require a component that is long particularly in the weft direction, because the coated base fabric for the airbags of the present invention is less likely to undergo post-sewing yarn slippage during cutting of a component that is long in the weft direction. Additionally, since the coated base fabric for airbags of the present invention is also excellent in packageability, airbags that are particularly required to have packageability are also preferable. Specifically, driver airbags, front-passenger airbags, and curtain airbags are preferable.

### EXAMPLES

The following describes the present invention in more detail with reference to Examples. However, the present invention is not limited by the following Examples, and can of course be implemented with appropriate changes to the extent that the changes conform to the purposes described above and below, all changes of which are included in the technical scope of the invention. The test methods for various performance conducted in the following Examples are as follows.

### Areal Weight of Base Fabric

The measurement was performed in accordance with JIS L 1096 (2010) 8.3.2. Two test specimens measuring about 200 mm×200 mm were taken from a base fabric to which a coating agent was applied, and the absolute dry mass (g) of each specimen was weighed to determine the mass per square meter (g/m²). The average was calculated to determine the areal weight.

### Weaving Density of Base Fabric

The measurement was performed in accordance with JIS L 1096 (2010), 8.6.1. Specifically, a sample was placed on a flat table, and unnatural wrinkles and tension were removed. The number of warp and weft yarns in a 2.54 cm section was counted at five different positions, and the average for each unit length was calculated to determine the density.

### Tear Strength of Base Fabric

The measurement was performed in accordance with JIS L 1096 (2010), 8.17 Method A (Single Tongue Method).

Specifically, five test pieces measuring 7.5 cm×20 cm were taken from the sample in each of the vertical direction and the horizontal direction. An 80 mm cut was made in a direction perpendicular to the short side at the center of the short side. Each test piece was set on a tensile tester with a distance between grips of 75 mm for measurement with a load cell of 500 kgf at a tensile speed of 200 mm/min, whereby a first local maximum and a stress-strain curve were obtained. The strain was determined by the following formula: strain (%)=sample elongation (mm)÷gauge length (75 mm)×100. The stress-strain curve was obtained with the stress (N) on the vertical axis and the strain (%) on the horizontal axis, and the slope at 300 N was determined by the following formula (1):

$$Slope = 300 N / {ε}_{300 N} \qquad ( 1 )$$

where t is the slope, and ε_{300 N} is the strain (%) at 300 N.

### Stiffness of Base Fabric

The measurement was performed in accordance with EASC 9904 0180 A09 (2009.12.11) 3.16 Stiffness. Specifically, five test pieces measuring 4 inch×8 inch were taken from the sample in each of the vertical direction and the horizontal direction for measurement using a stiffness tester (SASD-672). Then, the average was calculated from the values in the warp direction (n=5) and the weft direction (n=5).

### Air Permeability of Base Fabric

The measurement was performed in accordance with JIS L 1096 (2010). 8.26.1 Method A (Frazir-type method). Specifically, five test pieces measuring 10 cm×5 cm were taken from the sample. Air was sucked in to a pressure of 125 Pa in a Frazir-type tester (FX-3300 LabAir IV), and the measurement was performed with a measurement size of 5 cm².

### Scrubbing of Base Fabric

The test was performed in accordance with ISO 5981. Specifically, five test pieces measuring 10 cm×5 cm were taken from the sample. Each test piece was fixed to a scrub tester (IMC-15D7-A type), and the scrub test was performed 200 times for each test piece with an initial load of 1 kgf.

Air Permeability of Base Fabric after Scrubbing

After performing the scrub test 200 times, the measurement was performed using a Frazir-type tester based on JIS L 1096 (2010). 8.26.1 Method A (Frazir-type method), with air sucked in to a pressure of 125 Pa and a measurement area of 5 cm².

### Coating Amount of Coating Agent on Base Fabric

A precise 5 cm square sample was taken from a polyester base fabric for airbags in which silicone resin has been cured. The sample was immersed in a solvent (hexafluoroisopropanol) that dissolves only the polyester fibers, i.e., the base fabric, to dissolve the base fabric. Subsequently, only the insoluble matter (a silicone-coated layer) was collected and washed with acetone. After vacuum drying, the sample was weighed. The coating amount is expressed as mass per square meter (g/m²).

### ICP Optical Emission Spectrometry on Zirconium

A sample (about 0.5 g) was taken from the polyester base fabric for airbags. The sample was blended with 60% nitric acid (10 mL), hydrofluoric acid (0.2 mL), and ultrapure water (2 mL) and then dissolved in an acid using a microwave sample decomposition device (UltraWAVE available from Milestone General K.K.). The dissolved sample was subjected to measurement of the concentration of zirconium (Zr) by the ICP optical emission spectrometric method (5900 ICP-OES available from Agilent) with a plasma output of 1200 W, a plasma gas flow rate of 12 L/min, a nebulizer gas flow rate of 0.7 L/min, and an auxiliary gas flow rate of 1.0 L/min.

Measurement of Elongation Recovery Rate of Resin after 10 Cycles of 50% Strain

A silicone resin sample for measurement of the elongation recovery rate was pressed at 200° C. and 10 MPa for 1 minute using a hot press machine to obtain a resin film with a constant thickness of 0.2 mm. Five dumbbell-shaped No. 7 test pieces were taken from the obtained resin film. Each test piece was held by chucks at both of its 7.5 mm ends without causing slack. The gauge length was set to 20 mm, the tensile speed was set to 200 mm/min, and the load cell was set to 500 gf. Under these conditions, a cycle of strain from 0 mm to 10 mm to 0 mm was performed 10 times, with the upper limit of the tension being 10 mm at which the strain of the gauge length reaches 50%. The elongation recovery rate was calculated based on the following formula (2):

$$Er = ( 1 - L \div 20 mm ) ) \times 100$$

where Er is the elongation recovery rate (%) after 10 cycles of 50% strain, and L is the elongation (mm) when the stress reached 0.01 N or less (rounded off to the third decimal place) after 10th cycle of strain from 10 mm to 0 mm.

### Total Fineness of Original Yarn

The measurement was performed in accordance with JIS L 1013 (2010) 8.3.1. Specifically, a precise 90 cm long original yarn sample was taken under an initial load. The absolute dry mass was measured, and the corrected fineness (dtex) was calculated based on the following formula (7). The average of five measurements was determined as the total fineness.

F0=1000×m/0.9×+(100+R0)/100 Formula (7)

where F0 is the corrected fineness (dtex), L is the length (m) of sample, m is the absolute dry mass (g) of the sample, and R0 is the official moisture content (%).

### Example 1

Polyester-multifilament original yarns with a fineness of 470 dtex/96f were used as the warp and weft yarns. Weaving was performed in a plain weave pattern with a water-jet loom. Subsequently, the fabric was passed through a hot-water shrinkage tank at 98° C. without drying and then continuously passed through a drying step to adjust the surface temperature of the base fabric to 120° C. at the outlet of the dryer (measured with a non-contact thermometer).

Then, one side of the woven fabric was coated with a solvent-based silicone resin composition to which an organic zirconium compound was added to adjust the zirconium element content to 230 ppm. The solvent-based silicone resin composition was applied by the knife-on-air method at a coating amount of 18 g/m², followed by curing such that the surface temperature of the base fabric was 170° C. at the outlet of the heat treatment device (measured with a non-contact thermometer), whereby a coated base fabric was obtained. Table 1 shows the physical properties of the obtained coated base fabric. The average air permeability after scrubbing in the warp and weft directions was 0.19 cc/cm²/sec, and the average stiffness in the warp and weft directions was 8 N, showing good results.

### Example 2

The same procedure as in Example 1 was repeated, except that the push-in depth of the knife in the coat was changed to 25 g/m². Table 1 shows the physical properties and the like of the obtained coated base fabric. The average air permeability after scrubbing in the warp and weft direction was 0.17 cc/cm²/sec, and the average stiffness in the warp and weft directions was 10 N, showing good results.

### Example 3

The same procedure as in Example 1 was repeated, except that polyester multifilament original yarns with a fineness of 555 dtex/144f were used as the warp and weft yarns, and the push-in depth of the knife in the coat was changed to 19 g/m². Table 1 shows the physical properties and the like of the obtained coated base fabric. The average air permeability after scrubbing in the warp and weft direction was 0.08 cc/cm²/sec, and the average stiffness in the warp and weft directions was 13 N, showing good results.

### Example 4

The same procedure as in Example 3 was repeated, except that the push-in depth of the knife in the coat was changed to 14 g/m². Table 1 shows the physical properties and the like of the obtained coated base fabric. The average air permeability after scrubbing in the warp and weft direction was 0.11 cc/cm²/sec, and the average stiffness in the warp and weft directions was 12 N, showing good results.

### Comparative Example 1

The same procedure as in Example 1 was repeated, except that polyester multifilament original yarns with a fineness of 555 dtex/144f were used as the warp and weft yarns, that the push-in depth of the knife in the coat was changed, and that a solvent-free silicone resin composition containing the same components, excluding zirconium element, at the same composition ratio as that used in Example 1 was applied at an amount of 20 g/m². Table 1 shows the physical properties and the like of the obtained coated base fabric. The average air permeability after scrubbing in the warp and weft direction was 1.83 cc/cm²/sec, and the average stiffness in the warp and weft directions was 18 N. Both the air permeability after scrubbing and the stiffness showed poor results.

### Comparative Example 2

The same procedure as in Example 1 was repeated, except that the push-in depth of the knife in the coat was changed and that a solvent-free silicone resin composition containing the same components, excluding zirconium element, at the same composition ratio as that used in Example 1 was applied at an amount of 25 g/m². Table 1 shows the physical properties and the like of the obtained coated base fabric. The average air permeability after scrubbing in the warp and weft direction was 1.58 cc/cm²/sec, and the average stiffness in the warp and weft directions was 15 N. While the stiffness was satisfied, the air permeability after scrubbing showed a poor result.

TABLE 1

| | | | Exam- | Exam- | Exam- | Exam- | Comparative | Comparative |
|---|---|---|---|---|---|---|---|---|
| Item | | Unit | ple 1 | ple 2 | ple 3 | ple 4 | Example 1 | Example 2 |
| Fineness | | dtex | 470 | 470 | 555 | 555 | 555 | 470 |
| Weaving Density | Warp | yarns/2.54 cm | 50.9 | 51.0 | 50.8 | 51.0 | 51.0 | 51.0 |
| | Weft | yarns/2.54 cm | 51.0 | 51.1 | 50.6 | 50.6 | 50.7 | 51.1 |
| Coating Amount | | g/m² | 18 | 25 | 19 | 14 | 20 | 25 |
| of Silicone Resin | | | | | | | | |
| Zirconium element | | ppm | 20 | 26 | 17 | 13 | — | — |
| Concentration | | | | | | | | |
| Stiffness | Warp | N | 8 | 10 | 14 | 12 | 17 | 14 |
| | Weft | N | 8 | 10 | 13 | 12 | 19 | 15 |
| | Ave | N | 8 | 10 | 13 | 12 | 18 | 15 |
| First Local Maximum | Warp | N | 328 | 312 | 453 | 422 | 432 | 275 |
| of Tear Strength | Weft | N | 348 | 341 | 508 | 478 | 434 | 282 |
| Slope from Origin | Warp | | 6.6 | 6.8 | 6.9 | 6.7 | 7.5 | 7.3 |
| Where Stress is 300N | Weft | | 6.2 | 6.5 | 6.5 | 6.5 | 7.1 | 7.0 |
| | Ave | | 6.4 | 6.7 | 6.7 | 6.6 | 7.3 | 7.2 |
| Initial Air | Warp | cc/cm²/sec | 0.06 | 0.04 | 0.02 | 0.04 | 0.01 | 0.02 |
| Permeability | Weft | cc/cm²/sec | 0.07 | 0.04 | 0.02 | 0.05 | 0.02 | 0.02 |
| Air Permeability after | Warp | cc/cm²/sec | 0.17 | 0.14 | 0.07 | 0.10 | 1.63 | 1.37 |
| Scrubbing 200 Times | Weft | cc/cm²/sec | 0.21 | 0.19 | 0.09 | 0.12 | 2.02 | 1.78 |
| | Ave | cc/cm²/sec | 0.19 | 0.17 | 0.08 | 0.11 | 1.83 | 1.58 |

The present invention provides a polyester base fabric for airbags, in which the polyester base fabric, while its poor packageability is improved, suppresses a reduction in air permeability after being rubbed during packaging and/or deployment. This makes it possible to promote the use of polyester airbags that enable a reduction in carbon dioxide emissions, thus greatly contributing to industrial development.

1. A polyester base fabric for airbags, comprising a woven fabric containing polyester fibers and having silicone resin applied in an amount of 5 g/m² to 25 g/m² to one side of the woven fabric,
wherein an average stiffness in the warp and weft directions is 15 N or less,
a first local maximum of tear strength is 300 N or more in each of the warp direction and the weft direction,
an average slope from the origin to a point where the stress is 300 N in the warp and weft directions is 7.0 or less in a stress-strain curve obtained in a tear test, with a vertical axis representing stress (N) and a horizontal axis representing strain (%), and
an average air permeability in the warp and weft directions after 200 scrub tests is 0.3 cc/cm²/sec or less.

2. The polyester base fabric for airbags according to claim 1, wherein the polyester base fabric contains 10 ppm or more of zirconium.

3. The polyester base fabric for airbags according to claim 1, wherein the polyester fibers have a total fineness of 200 dtex to 600 dtex.

4. An airbag comprising the polyester base fabric for airbags according to claim 1.
